(19) United States
(12) Patent Application Publication
(10) Pub. No.: US 2010/0067669 A1
(43) Pub. Date: Mar. 18, 2010

(54) Personalized Web Based Integrated Voice Response System (Celebritiescallyou.com)

(76) Inventors: Chris Albert Webb, Louisville, KY (US); James Yelich, Brentwood, TN (US); Richard Charles King, Glenview, KY (US)

Correspondence Address: Chris Webb;James Yelich, 310 West Liberty Street, Suite 204, Louisville, KY, 40202, US

(21) Appl. No.: 12/557,808

(22) Filed: Sep. 11, 2009

Related U.S. Application Data
(60) Provisional application No. 61/096,842, filed on Sep. 14, 2008.

(51) Int. Cl. H04M 1/64

(52) U.S. Cl. 379/88.17

(57) ABSTRACT

To offer clients the unique ability to send a message from their favorite celebrity to their friends, family, and loved ones that is completely custom and personalized to sound as if that celebrity was actually calling them. Provisioned caller ID feature so the celebrities name will appear on the handset when the call is being delivered.

This application claims benefit of provisional application Ser. No. 61/096,842 filed on Sep. 14, 2008.

The present invention relates to a personalized web based integrated voice response system (celebritiescallyou.com).

The device is comprised of the following components:

Professionally recorded and edited scripts, web site with flash and e-commerce capabilities, mySQL database, mp3 file compiler, mp3 to wave transcoder, custom API integration tool, IVR phone system with voice detection software.

Professionally recorded and edited scripts are stored in a mySQL database which populates the drop down menus on the web site. After client has selected the drop downs that they would like to send the mp3 compiler pulls from the database the original script files along with the drop down files that the client selected and compiles them into one message. That message is then available to be previewed by the client. Upon approval by the client they will then be taken to the e-commerce portion of the web site to actually pay for the service and fill out the scheduler information to send the message. After system receives payment message is then delivered at the date, time, and choice of client. If client selected phone message the customized message is then transcoded from an mp3 file to a wave file in the CCITT u-Law format. Once converted it is then sent electronically via a special API tool to our IVR system which places the call and determines if there is a human voice. If a human voice is detected using the voice detection software, then the message is played. If a voicemail system is detected, then the voice detection software waits for the beep to leave the message. If the client chooses to deliver the message via email, the website uses JavaScript to create a custom HTML email which it sends to the friend with a link to another custom HTML page which contains the compiled customized mp3 file. The customized message can be sent either through our custom IVR system directly to a phone number or via email where they are given a link to their customized message. When we transcode the client's customized script we take those pre-recorded files which are stored in MP3 format compile them and convert the compiled file into a specialized format (CCITT u-Law file format) which is specifically formatted for the maximum quality and frequency to be transmitted over the phone system and then delivered to our IVR system. Our IVR system actually facilitates the phone call. As the call is made, it uses the voice detection software to detect when the friend answers the phone. If no human voice is detected, then IVR system determines if a voicemail system is in place. If a voicemail system is detected then, it then waits for the beep and plays the customized message in the CCITT u-Law format and then hangs up the phone. Provisioned caller ID feature that places the celebrities name on the handset when the call in being placed if no human voice answers, and there is no voicemail system in place, the IVR system will reschedule another time to attempt the call within 30 minutes. There is a maximum of 3 tries to attempt the call before the customized is sent via HTML email to the friend.

The customized message can be scheduled up to 1 (one) year in advance and still be delivered via both as a phone call and email. We can also use this system as an activity reminder system. Uses are similar to greeting cards and e-cards in which they provide inspiration and uplifting messages along with the entertainment factor of having their favorite celebrities deliver those messages. Personalized to the consumers liking, addresses the consumer by their first name.

### DRAWING DESCRIPTION

FIG. 1: is a schematic block diagram explaining the function of the invention 10.

FIG. 2: is a schematic block diagram explaining how the components of the invention 10 work together.

FIG. 3: is a screen shot of a Celebrity E-message from invention 10.

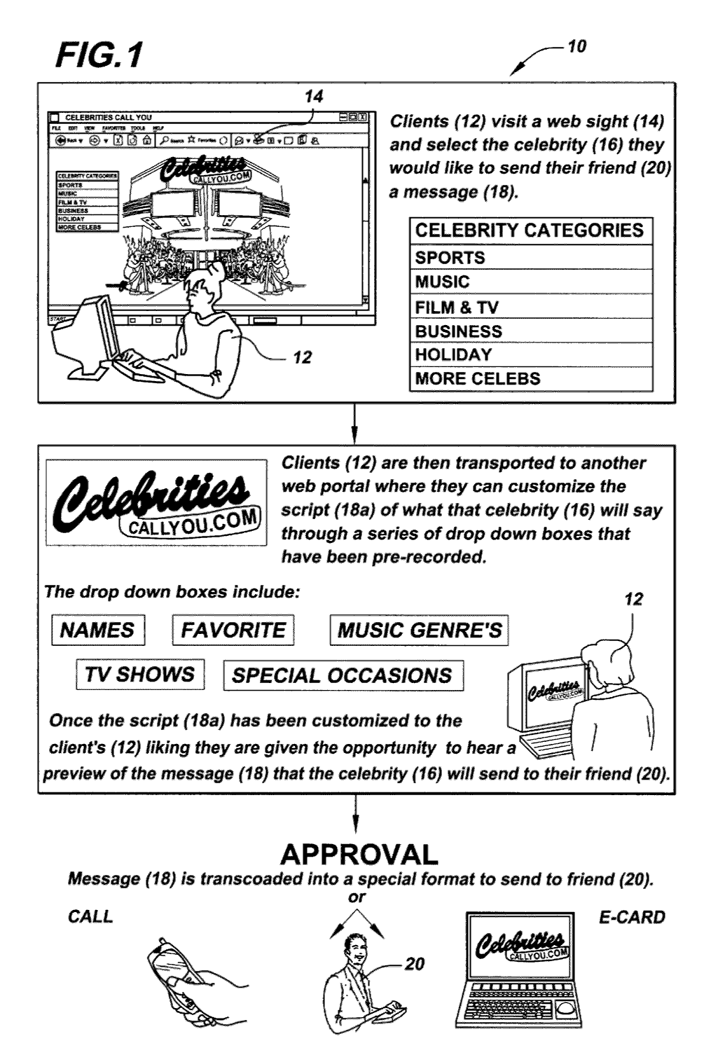

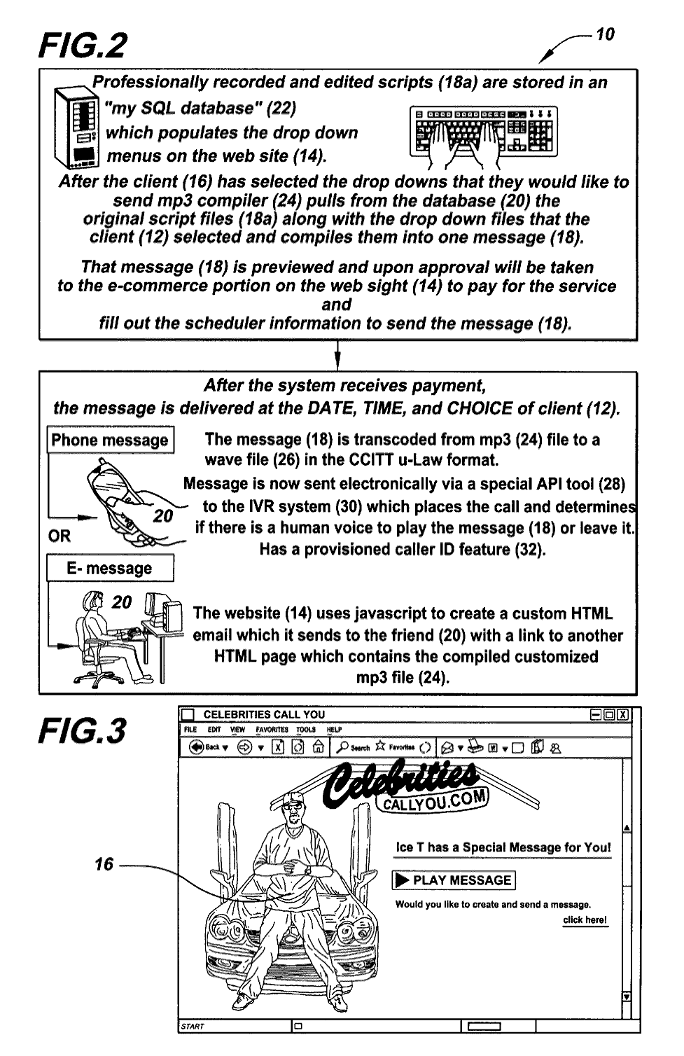

### DESCRIPTION LIST

10: is the overall invention.
12: is the client.
14: is the web site.
16: is any celebrity.
18: is the finished edited message customized by client 12.
18a: professionally recorded original scripts.
20: is the friend who will receive the message 18.
22: is the “mySQL” database.
24: is the mp3 file compiler.
26: is the mp3 to wave transcoder.
28: is the custom API integration tool.
30: is the IVR phone system with voice detection software.
32: is the provisioned caller ID feature.

What is claimed is:

1. Clients visit a web site and select the celebrity they would like to send their friend a message. They are then transported to another web portal where they can customize the script of what that celebrity will say through a series of drop down boxes that have been pre-recorded. These drop down boxes include names, favorite foods, TV shows, music genres, and special occasions. Once the script has been customized to the client's liking they are given the opportunity to hear a preview of the message that the celebrity will send to their friend. After approval, this message will then be transcoded into a special format and either sent directly to their friends mobile phone through a specialized IVR (Integrated Voice Response) system that will play the message only when their friend answer's the phone (the system is designed that if a voice mailbox system is detected, it will wait until it hears the beep and it will leave the customized message in the friend's mailbox) provisioned caller Id so the celebrity name will appear on the handset when the call is being placed or send a link via an HTML email that will contain a link to the customized message.
